(19) United States
(12) Patent Application Publication
(10) Pub. No.: US 2013/0237945 A1
(43) Pub. Date: Sep. 12, 2013

(54) DRUG STORAGE CONTAINER

(71) Applicants: Junichi Ogawa, Nakakoma-gun (JP); Kouichi Tachikawa, Fujinomiya-shi (JP)

(72) Inventors: Junichi Ogawa, Nakakoma-gun (JP); Kouichi Tachikawa, Fujinomiya-shi (JP)

(73) Assignee: TERUMO Kabushiki Kaisha, Shibuya-ku (JP)

(21) Appl. No.: 13/988,284

(22) PCT Filed: Nov. 14, 2011
(86) PCT No.: PCT/JP2011/076145

§ 371 Date: May 17, 2013

(30) Foreign Application Priority Data
Nov. 18, 2010 (JP) 2010-257625

(51) Int. Cl. A61J 1/18

(52) U.S. Cl. CPC A61J 1/18
USPC 604/404

(57) ABSTRACT

A drug storage container includes a storage bag formed of a sheet-shaped member and configured to store a drug therein and a measurement unit attached to said storage bag. The measurement unit is marked with a scale for measuring the drug left in said storage bag after discharging a portion of the drug from said storage bag. Further the measurement unit is formed of a tubular material having a hardness so as not to undergo deformation depending on the variation in amount of the drug left in the storage bag.

This application is the national phase entry under U.S.C. §371 of International Application No. PCT/JP2011/076145, filed on Nov. 14, 2011, which claims priority under 35 U.S.C. §119 to Japanese Patent Application No. JP2010-257625, filed on Nov. 18, 2010, the contents of which are hereby incorporated by reference in their entirety for all purposes.

### TECHNICAL FIELD

This invention relates to a drug storage container for storing a drug in a storage bag formed of a sheet material.

### BACKGROUND ART

As this type of existing drug storage container, there is known one described, for example, in Japanese Patent Laid-Open No. 2001-314487 (hereinafter Patent Document 1). In the Patent Document 1, there is described a technique wherein a drug is stored in a pouch-shaped flexible storage bag, and a discharge unit attached to the storage bag so as to discharge the drug, for example, by puncturing with a needle of an injector.

It will be noted that with respect to a drug whose dosage to man is determined depending on the body weight and body surface area, after completion of an adjustment work, it is necessary to confirm whether an adjusted drug is prescribed as indicated. In recent years, in order to exactly control an amount of drug, it has been required not only to check the amount of drug used (administered), but also to measure the amount of drug remaining (hereinafter referred to as “residual liquid amount”) in a storage bag of a drug storage container to doubly check the amount of the drug.

However, the drug storage container set out in the Patent Document 1 is not marked with a scale for measuring an amount of drug after use. In order to confirm the residual liquid amount, a work for removing the drug from the storage bag has to be made, so that the checking operation of the residual liquid amount has become complicated.

Another proposal is directed toward one wherein a scale is marked on a storage bag. However, because the storage bag is formed of a flexible sheet-shaped member, the bag is thus expanded when a drug is filled therein and becomes shriveled after discharge of the drug. Accordingly, the volume in the storage bag varies depending on the change in amount of the drug and thus, it could not be possible to accurately measure the residual liquid amount.

An object of the invention is to provide, while taking the above problems into consideration, a drug storage container that allows accurate confirmation of an amount of drug left in a storage bag.

### SUMMARY OF THE INVENTION

In order to solve the above-stated problems and achieve the object of the invention, a drug storage container of the present invention includes a storage bag formed of a sheet-shaped member and storing a drug therein, and a measurement unit attached to the storage bag and marked with a scale for measuring a drug left in the storage bag after discharge of the drug from the storage bag. The measurement unit is formed of a tubular material having such a hardness as not to undergo deformation depending on the variation in amount of the drug.

According to the drug storage container of the present invention, the measurement unit is formed of a material that has such a hardness as not to undergo deformation depending on the variation in amount of drug, so that the measurement unit is not deformed by filling or discharging the drug. Thus, an amount of the drug left in the storage bag can be accurately confirmed without withdrawing the drug from the storage bag. This allows an amount of the drug used and an amount of the drug left in the storage bag to be doubly confirmed, thus enabling the drug to be severely controlled in amount.

### BRIEF DESCRIPTION OF DRAWINGS

The present disclosure is described in conjunction with the appended figures:

FIG. 1 is a plan view showing a first embodiment of a drug storage container of the invention.

FIG. 2 is a partial sectional view showing a sectioned state of an essential part of the first embodiment of the drug storage container of invention.

FIG. 3 is an enlarged plan view showing a state in use of a measurement unit in the first embodiment of the drug storage container of the invention.

FIG. 4 is a plan view showing a second embodiment of a drug storage container of the invention.

### DETAILED DESCRIPTION OF THE INVENTION

Embodiments of the present invention will be described hereinafter with reference to the accompanying drawings, in which preferred exemplary embodiments of the invention are shown. The ensuing description is not intended to limit the scope, applicability or configuration of the disclosure. Rather, the ensuing description of the preferred exemplary embodiments will provide those skilled in the art with an enabling description for implementing preferred exemplary embodiments of the disclosure. It should be noted that this invention may be embodied in different forms without departing from the spirit and scope of the invention as set forth in the appended claims.

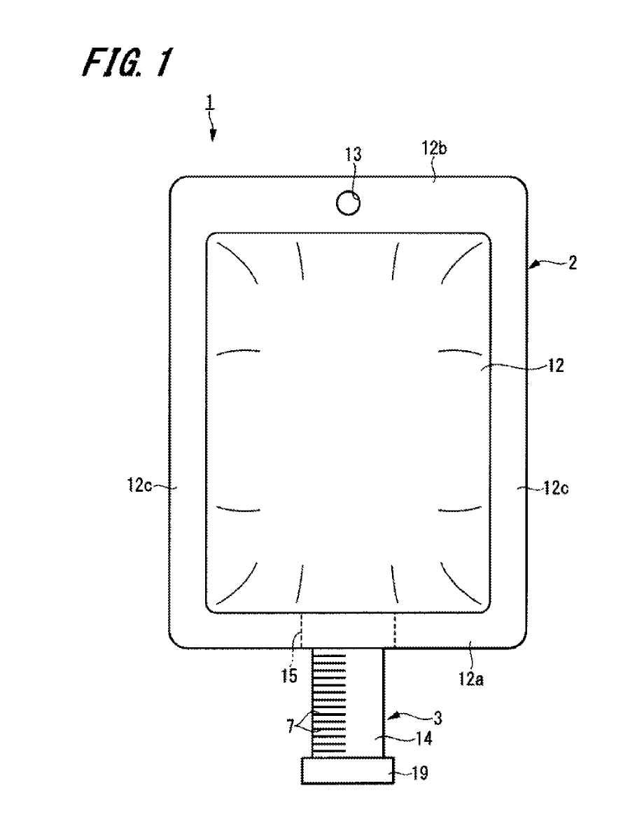

The embodiments of a drug storage container of the invention are now illustrated with reference to FIGS. 1 to 4. It will be noted that like members are indicated by like reference numerals throughout the drawings The illustration is made in the following order:
1. First Embodiment
1-1. Configuration of Drug Storage Container
1-2. Use Method of Drug Storage Container
2. Second Embodiment
<1. First Embodiment>
1-1. Configuration of Drug Storage Container

Initially, referring to FIGS. 1 to 3, the configuration of a drug storage container according to the first embodiment of the present invention (hereinafter referred to “present embodiment”) is illustrated.

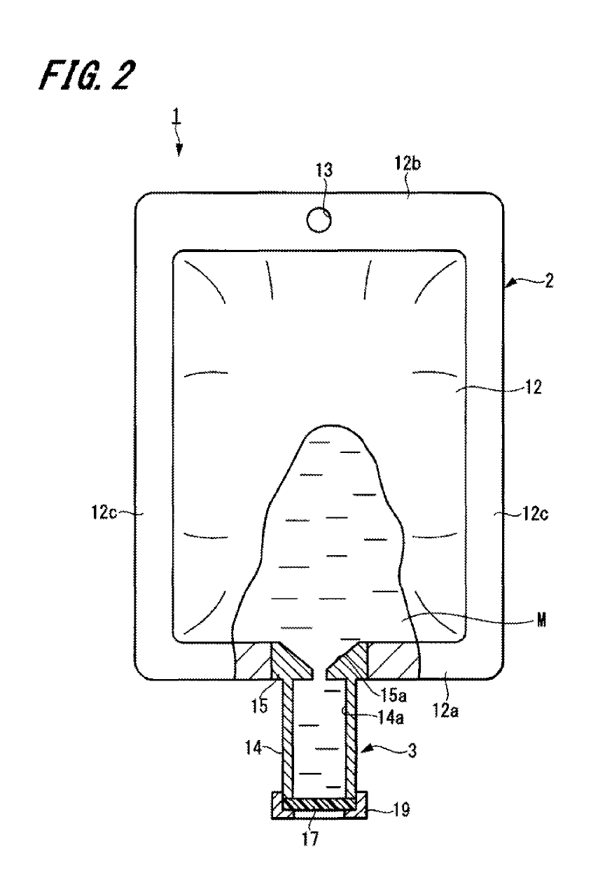

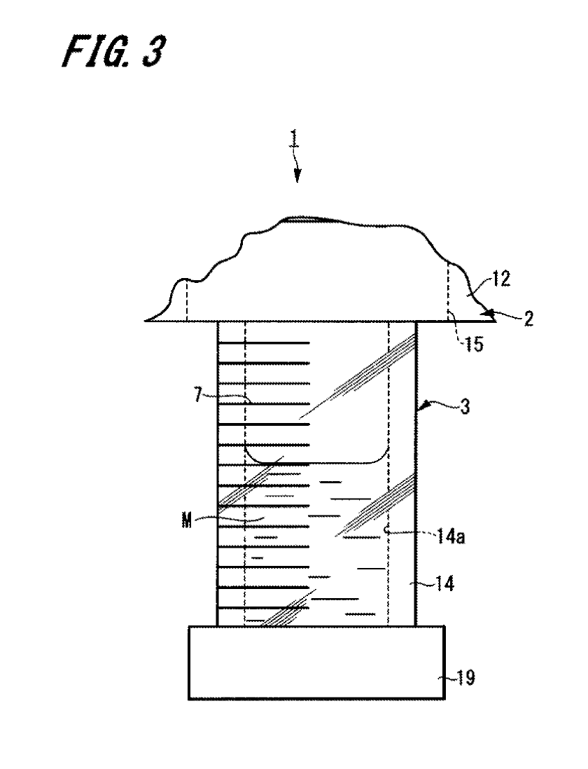

FIG. 1 is a plan view of a drug storage container of the present embodiment, and FIG. 2 is a partial sectional view of the drug storage container of the present embodiment. FIG. 3 is a view showing a state in use of the drug storage container of the present embodiment.

A drug storage container 1 is a container storing a drug, such as, for example, a protein drug like an antibody, a peptide drug like a hormone, a nucleic acid drug, a cell drug, a blood preparation, vaccines for preventing various types of infectious diseases, an anticancer drug, an anesthetic agent, a narcotic drug, an antibiotic drug, a steroid drug, a protease inhibitor, heparin, a sugar injection like glucose, an injection for correction of electrolyte, such as sodium chloride or potassium lactate, a vitamin preparation, a fat emulsion, a contrast agent, an antihypnotic agent or the like.

As shown in FIG. 1, the drug storage container 1 is configured of a storage bag 2 in which a drug M is filled, and a discharge unit 3 from which the drug M stored in the storage bag 2 is discharged.

### [Storage Bag]

The storage bag 2 is formed as a pouch by superposing two sheets 12 of substantially rectangular form along the peripheral margins thereof. The two sheets 12 are bonded or fused at an tip end portion 12a which is one of ends along the lengthwise direction and a base end portion 12b at a side opposite to the tip end portion 12a and also at two lateral side portions 12c connecting the tip end portion 12a and base end portion 12b. The fusing method includes, for example, heat sealing, high frequency sealing, ultrasonic sealing and the like. The bonding method includes, for example, bonding with an adhesive, bonding using a solvent or the like.

Substantially at a center of the base end portion 12b of the sheets 12 of the storage bag 2, there is provided a suspension hole 13 for a hanger or the like suspending the storage bag 2. A discharge unit 3 is attached substantially at a center of the tip end portion 12a of the sheets 12 of the storage bag 2. The capacity of the storage bag 2 is set, for example, at 0.5 cc to 600 cc.

The sheets 12 constituting the storage bag 2 should preferably be made of a transparent or semi-transparent material so as to allow easy confirmation of incorporation of foreign matters or reaction which may occur when a plurality drugs are used by mixing. The materials for the sheets 12 include, for example, low density polyethylene, ethylene vinyl acetate copolymer, polypropylene-based copolymers, soft polyvinyl chloride and the like. Besides, there may be used those obtained by formulating at least two types of thermoplastic elastomers in polypropylene thermoplastic resin.

It will be noted that although an example of configuring the storage bag 2 by fusing or bonding the two sheets 12 along the peripheral margins thereof in the present embodiment has been illustrated above, the invention should not be construed as limited thereto. For instance, a pouch-shaped storage bag may be formed by forming a sheet in tubular form according to an inflation method and fusing or bonding the tubular sheet at openings of opposite ends. Moreover, aside from the inflation method, the sheet 12 may be made by other many methods including a blow molding method, a dry laminate method, a hot melt laminate method, a co-extrusion inflation method, a co-extrusion T-die method, a hot press method and the like.

### [Discharge Unit]

Next, the discharge unit 3 is described with reference to FIGS. 2 and 3.

As shown in FIG. 2, the discharge unit 3 has a connection portion 15 connected to a tubular body 14 and the storage bag 2. The tubular body 14 is formed substantially in cylindrical form and is opened at the axial opposite ends thereof. The connection portion 15 is continuously formed at one axial side of the tubular body 14. A sealing member 17 is attached to the other axial side of the tubular body 14 so as to seal the opening.

The connection portion 15 is provided with a through-hole 15a connecting with a tubular hole 14a of the tubular body 14 and the storage bag 2 therethrough. The diameter of the through-hole 15a is so set as to decrease on coming nearer to the tubular body 14. It will be noted that the through-hole 15a may have the same diameter as the tubular hole 14a over the whole length thereof.

The connection portion 15 is sandwiched between the two sheets 12 at the tip end portion 12a of the storage bag 2. The connection portion 15 is fused or bonded along with the two sheets 12 and fixed to the storage bag 2. In this embodiment, in order to increase the area contact between the connection portion 15 and the two sheets 12, the connection portion 15 is arranged substantially in rhombic, boat-shaped or flat form as viewed from the opening side of the through-hole 15a. It will be noted that the connection portion 15 may be formed substantially in cylindrical form.

Further, a ring-shaped cap member 19 is fitted at the other axial side of the tubular body 14. This cap member 19 is fixed by fitting or screwing at the other axial side of the tubular body 14. The cap member 19 serves to prevent the sealing member 17 from falling off from the tubular hole 14a of the tubular body 14. By the provision of the cap member 19 and the sealing member 17, the drug M is prevented from leaking off from the opening of the tubular body 14.

It will be noted that although it has been illustrated in the present embodiment that the fixing of the cap member 19 to the tubular body 14 is made by fitting or screwing with the body, the manner of fixing the cap member 19 should not be limited to the fitting or screwing. For the fixing of the cap member 19, other many fixing methods including caulking, fusing, and bonding with a bonding agent and the like may be used.

As a material for the cap member 19, there can be used engineering plastics, metals and the like.

The sealing member 17 should be one that is able to be punctured with a needle of a medical device, such as an injector. When a needle is punctured through the sealing member 17, the inner space between the storage bag 2 and the discharge unit 3 and the outer side of the sealing member 17 are communicated with each other. This makes it possible to discharge the drug M from the storage bag 2 or inject the drug M into the storage bag 2.

It will be noted that although an instance where the sealing member used is one capable of being punctured with a needle has been illustrated in the present embodiment, limitation should not be applied only to this instance. The sealing member 17 may be constituted, for example, in the form of a valve having a slit. If the sealing member 17 is provided as a valve, the valve is deformed, without puncture of a needle, by insertion of various types of medical devices or tubular bodies, such as a transfusion container, thereby opening the slit (see, for example, Japanese Patent Laid-Open No. 2010-246829), or when a tubular body per se is inserted into the slit, the inner space between the storage bag 2 and the discharge unit 3 and the outer side of the sealing member 17 is communicated with each other.

Although the material for the sealing member 17 is not limited particularly, it is preferred to constitute the sealing member with an elastic material so as to ensure good liquid tightness with the tubular body 14. There can be used, for example, elastic materials including various types of rubber materials, such as natural rubber, butyl rubber, isoprene rubber, butadiene rubber, styrene-butadiene rubber, silicone rubber and isobutylene rubber, various types of thermoplastic elastomers, such as polyurethane, polyester, polyamide, olefin and styrene elastomers, or elastic materials like mixtures thereof.

Further, as shown in FIG. 3, the tubular body 14 is marked with a scale 7 on the side face thereof at equal intervals along the axial direction. This scale 7 is formed by printing or stamping on the side face of the tubular body 14. The tubular body 14 of the discharge unit 3 of the present embodiment not only serves to discharge the drug M, but also serves as a measurement unit of measuring a residual amount of the drug M.

For the material for the discharge unit 3 having such a configuration as set out above, mention is made, for example, of various types of resins including polyvinyl chloride, polyethylene, polypropylene, cyclic polyolefins, polystyrene, poly(4-methylpentene-1), polycarbonates, acrylic resins, acryl nitrile-butadiene-styrene copolymer, polyesters like polyethylene terephthalate, butadiene-styrene copolymer, polyamides (e.g. nylon 6, nylon 6-6, nylon 6-10 and nylon 12) and the like. Of these, it is preferred in view of the ease in molding to use resins, such as polypropylene, cyclic polyolefins, polyesters and poly-(4-methylpentene-1).

It is to be noted that since the tubular body 14 of the discharge unit 3 has a role as a measuring unit, substantially transparent or semi-transparent materials are used to secure visibility of inside contents. Moreover, for a correct measurement of the residual liquid amount, it is required that the volume inside the tubular body 14 be not varied. Accordingly, the tubular body 14 is formed of a material, which is harder than the material for the sheet 12 and has such a hardness as not to be deformed depending on the variation in amount of the drug M.

In this way, when the tubular body 14 is formed harder than the storage bag 2, no deformation of the tubular body 14 occurs depending on the amount of the drug M as with the case of the storage bag 2. That is, the volume inside the tubular body 14 does not change at all. This allows a correct measurement of an amount (residual amount) of the drug M left in the storage bag 2 with the scale 7 provided on the tubular body 14.

In the storage bag 2 and the discharge unit 3, there are filled the drug M and a gas (e.g. air) in an amount substantially equal to the capacity of the tubular body 14 of the discharge unit 3. Since a gas in an amount substantially equal to the capacity of the tubular body 14 is filled, all the residual liquid can be poured into the tubular hole 14a of the tubular body 14. The capacity of the tubular body 14 serving as a measuring unit is set, for example, at 0.5 cc to 600 cc.

It will be noted that although an instance where the tubular body 14 of the discharge unit 3 is formed substantially in cylindrical form has been illustrated above, the tubular body 14 may be formed in hollow quadratic or hexagonal prism.

### 1-2. Use Method of Drug Storage Container

Next, referring to FIGS. 1 to 3, how to use the drug storage container 1 having such a configuration as stated hereinabove is now illustrated.

Initially, a needle of a medical device such as an injector is punctured into the sealing member 17 of the discharge unit 3 of the drug storage container 1. In doing so, an inner space between the storage bag 2 and the discharge unit 3 and the outside are communicated with the needle. Next, the drug M filled in the storage bag 2 is withdrawn in an amount necessary for use (dose). At this stage, the amount of the drug M used is checked.

Next, as shown in FIG. 3, the other axial side of the tubular body 14 of the discharge unit 3 is turned downward in the vertical direction. This permits the drug M left in the storage bag 2 to be poured into the tubular body 14 of the discharge unit 3. The storage bag 2 and the discharge unit 3 have air enclosed therein in an amount substantially equal to the capacity of the tubular body 14. Accordingly, the drug M left in the storage bag 2 can be transferred to the tubular body 14 of the discharge unit 3 without provision of an air hole at the storage bag 2 or the discharge unit 3.

The residual liquid amount can be measured by reading out the scale 7 provided on the side face of the tubular body 14. The tubular body 14 has a hardness which is higher than the storage bag 2 and is one sufficient not to allow deformation depending on the variation in amount of the drug M. Thus, the tubular body 14 does not undergo deformation depending on the variation in amount of the drug M unlike the storage bag 2. More particularly, the volume in the tubular body 14 does not change, so that the residual liquid amount can be correctly measured. As a consequence, not only the amount of the drug M used, but also the residual liquid amount can be measured, and accordingly, the amounts of the drug M can be doubly confirmed.

### Second Embodiment

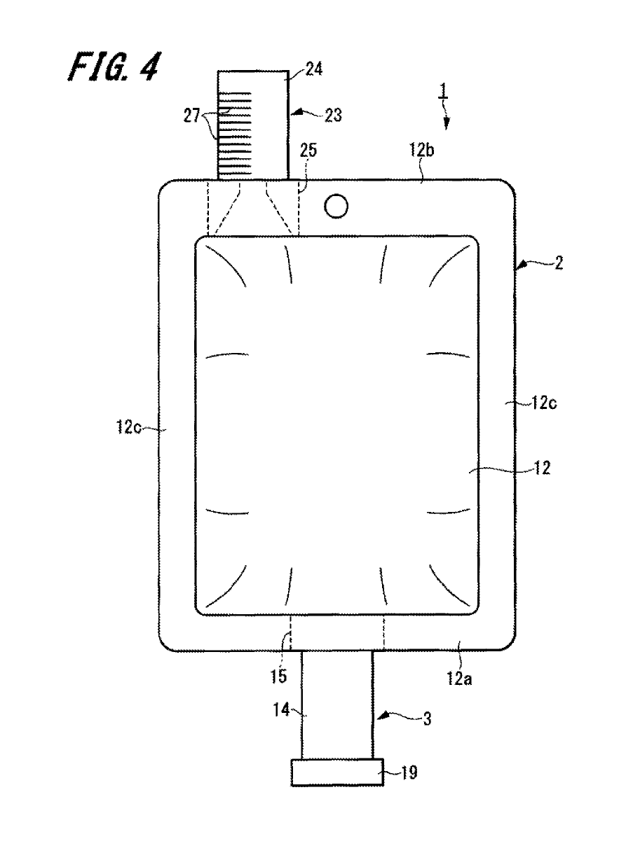

Next, a second embodiment of a drug storage container of the present invention is illustrated with reference to FIG. 4.

FIG. 4 is a plan view showing a drug storage container according to the second embodiment.

The difference of a drug storage container 21 according to the second embodiment from the drug storage container 1 of the first embodiment resides in that a discharge unit and a measurement unit are provided as separate members. For this reason, a measurement unit alone is illustrated herein, and portions common to the drug storage container 1 are indicated by same reference numerals, respectively, and are not illustrated again.

As shown in FIG. 4, the drug storage container 21 is constituted of a storage bag 2, a discharge unit 3 and a measurement unit 23. In the drug storage container 21 of the second embodiment, a scale is not marked on a side face of a tubular body 14 of the discharge unit 3.

The measurement unit 23 is disposed at a base end portion 12b of the storage bag 2. This measurement unit 23 is formed as shifted from a suspending hole 13 at the base end portion 12b. The measurement unit 23 has a measuring tube 24 and a connection portion 25 for measurement.

The measuring tube 24 is formed substantially in a cylindrical form closed at one axial side. The measuring tube 24 has a scale 27 graduated at equal intervals along an axial direction. At the other axial side of the measuring tube 24, there is contiguously provided the connection portion 25 for measurement.

The connection portion 25 for measurement is sandwiched between the two sheets 12 at the base end portion 12b of the storage bag 2. The other set-up of the connection portion 25 for measurement is similar to the connection portion 15 of the discharge unit 3 and is not described herein again.

Like the discharge unit 3, the materials for the measuring tube 24 of the measurement unit 23 include, for example, resins, such as polyvinyl chloride, polyethylene, polypropylene, cyclic polyolefins, polystyrene, poly-(4-methylpentene-1), polycarbonates, acrylic resins, acrylnitrile-butadiene-styrene copolymer, polyesters like polyethylene terephthalate, butadiene-styrene copolymer, and polyamides (e.g. nylon 6, nylon 6-6, nylon 6-10 and nylon 12). Of these, it is preferred in view of the ease in molding to use resins, such as polypropylene, cyclic polyolefins, polyesters and poly-(4-methylpentene-1).

It will be noted that the measuring tube 24 used should be substantially transparent or semi-transparent in order to ensure inside visibility. Moreover, it is required that the volume in the measuring tube 24 do not change so as to correctly measure the residual liquid amount. To this end, the measuring tube 24 is formed, like the tubular body 14 of the first embodiment, of a material which is harder than the sheets 12 of the storage bag 2 and has such a hardness as not to undergo deformation depending on the variation in amount of the drug M.

An instance where the measuring tube 24 is cylindrically formed has been illustrated above, but may not be limited thereto. That is, the measuring tube 24 may be formed, for example, in the form of a quadangular or hexagonal tube. Moreover, an instance where the measurement unit 23 is located as shifted from a portion, at which the suspending hole 13 is provided at the base end portion 12b of the storage bag 2, has been illustrated, but is not limited thereto. For instance, the measurement unit 23 may be located approximately at the center of the base end portion 12b of the storage bag 2, under which the suspending portion is formed at an axial one side of the measuring tube 24.

Where the residual liquid amount is measured by means of the drug storage container 21 according to the second embodiment, the base end portion 12b of the storage bag 2 at which the measurement unit 23 is provided is turned downward in the vertical direction. Subsequently, the drug M left in the storage bag 2 is poured into the measuring tube 24 of the measuring portion 23 to measure the residual liquid amount. In the storage bag 2, discharge unit 3 and measurement unit 23, a gas (air) has been preliminarily enclosed in an amount substantially equal to the capacity of the measuring tube 24. By this, the drug M left in the storage bag 2 can be readily transferred to within the measuring tube 24 without provision of an air hole.

Other set-ups are similar to those of the drug storage container 1 according to the first embodiment set out hereinbefore and are not illustrated again. According to the drug storage container 21 having such set-ups as stated above, similar features and effects can be obtained as with the case of the drug storage container 1 of the first embodiment.

It will be noted that the invention should not be construed as limited to the embodiments stated above and illustrated in the drawings, and many variations may be possible without departing from the spirit of the invention set forth in the claims. For instance, the measurement unit 23 may be provided at a portion other than the lateral side 12c of the storage bag 2 or the superposed portion of the sheets 12.

A weakly sealed portion, which may be peeled off by a user, may be provided between the connection portion 15 of the discharge unit 3 and the inner space of the storage bag 2 or between the connection portion 25 for measurement of the measurement unit 23 and the inner space of the storage bag 2. This weakly sealed portion is formed by bonding or fusing of the two sheets 12 configured to form the storage bag 2. When the drug M is discharged from the storage bag 2 or the residual liquid amount is measured, the weakly sealed portion is peeled off thereby permitting the tubular body 14 of the discharge unit 3 and the measuring tube 24 of the measurement unit 23 to be communicated with the inner space.

It will be noted that if the weakly sealed portion is provided, a gas (air) may be preliminarily filled in the tubular body 14 or measuring tube 24. Since the tubular body 14 or measuring tube 24 is preliminarily filled with a gas (air), there is no need of filling a gas within the storage bag 2 in an amount equal to the capacity of the tubular body 14 or measuring tube 24.

Further, a weakly sealed portion may be provided by fusing or bonding of the two sheets 12 in such a way that the inner space of the storage bag 2 is divided into two sections. This enables different types of drugs to be stored in the storage bag 2. In this case, when used, the different types of drugs may be mixed by peeling off at the weakly sealed portion.

### INDUSTRIAL APPLICABILITY

The invention can provide a drug storage container used to store, for example, a drug including a protein drug, like an antibody, a peptide drug like a hormone, a nucleic acid drug, a cell drug, a blood preparation, vaccines for preventing a variety of infectious diseases, an anticancer agent, an anesthetic drug, a narcotic drug, an antibiotic, a steroid agent, a protease inhibitor, heparin, a sugar injection like glucose, an injection for correction of electrolyte, such as sodium chloride or potassium lactate, a vitamin preparation, a fat emulsion, a contrast agent, an antihypnotic agent or the like.

While the principles of the disclosure have been described above in connection with specific apparatuses and methods, it is to be clearly understood that this description is made only by way of example and not as limitation on the scope of the invention.

1. A drug storage container comprising:
a storage bag formed of a sheet-shaped member and configured to store a drug therein; and
a measurement unit attached to said storage bag and marked with a scale for measuring a drug left in said storage bag after discharge of the drug from said storage bag,
wherein said measurement unit is formed of a tubular material having such a hardness as not to undergo deformation depending on the variation in amount of the drug.

2. The drug storage container according to claim 1, wherein said measurement unit is configured to function as a discharge unit discharging said drug and comprises a sealing member sealing an opening of said discharge unit.

3. The drug storage container according to claim 1, wherein said storage bag or said measurement unit contains air in an amount at least equal to a capacity of said measurement unit.

4. The drug storage container according to claim 1, further comprising:
a discharge unit attached to said storage bag as a separate member from said measurement unit so as to discharge said drug; and
a sealing member sealing an opening of said discharge unit.

5. The drug storage container according to claim 4, wherein said storage bag, said measurement unit or said discharge unit contains air in an amount at least equal to a capacity of said measurement unit and said discharge unit.
